(19) United States
(12) Patent Application Publication
(10) Pub. No.: US 2005/0098275 A1
(43) Pub. Date: May 12, 2005

(54) Guide rail arrangement

(75) Inventors: Thomas J Hormann, St. Wendel (DE); Herbert Brinkmann, Halle/Westfalen (DE)

Correspondence Address: Friedrich Kueffner, Suite 910, 317 Madison Avenue, New York, NY, 10017, US

(73) Assignee: Hormann KG Borockhagen, Steinhagen (DE)

(21) Appl. No.: 10/509,006

(22) PCT Filed: Apr. 15, 2002
(86) PCT No.: PCT/EP02/04159

(51) Int. Cl. E05D 15/06

(52) U.S. Cl. 160/201

(57) ABSTRACT

The invention relates to a guide rail arrangement for a door, particularly a sectional door, comprising a leaf. Said guide rail arrangement creates a track which is provided with two approximately linear segments and a connection segment joining the linear segments and is used for directing the movement of a door leaf between an open position and a closed position. The inventive guide rail arrangement comprises two rail elements which form a linear segment and are assembled so as to create a guide rail such that the linear segments of the track jointly enclose an angle of less than 180°, preferably about 90°. Each of the rail elements is provided with an essentially linear section and a curved section which is arranged at the end of the linear section, is produced as a single piece therewith, and forms the connection segment.

The invention pertains to a guide rail arrangement for a door with a leaf, especially a sectional door, to form a track for guiding the movement of the door leaf between an open position and a closed position, the track comprising two more-or-less straight segments and a connecting segment joining the two straight segments, with two rail elements, each of which serves to form a straight segment, which rail elements can be assembled to form a guide rail in such a way that the straight segments of the track enclose an angle of less than 180°, preferably of approximately 90°, with each other.

These types of guide rail arrangements are used, for example, to guide the movement of a door leaf of a sectional door between a closed position, in which the door leaf extends essentially in a vertical plane, and an open position, in which the door leaf extends overhead in a horizontal plane. For this purpose, the known guide rail arrangements usually have two guide rails, which are installed along the opposing lateral edges of the door leaf. Each of these guide rails has a straight section extending essentially in the vertical direction and a straight section extending essentially in the horizontal direction. In the closed position, the door leaf is located essentially between the straight sections of the vertical guide rails, whereas, when in the open position, it is usually located between the essentially horizontal straight segments. Between the straight segments of the track which guides the movement of the door leaf there is usually a connecting segment in the form of an arc of a circle, which merges at one end more-or-less tangentially with the straight vertical segment and at the other end with the straight more-or-less horizontal overhead segment. As a result of this arrangement of the guide rails, it is guaranteed that guide elements, such as guide rollers, which are attached to opposing lateral edges of the door leaf and which usually engage in the guide rails, and thus also the door leaf itself, can be moved smoothly along the track created by the guide rail arrangement between the closed position and the open position.

According to U.S. Pat. No. 5,036,899, the guide rails of a guide rail arrangement of this type can be obtained by first producing a straight guide rail and cutting it to a predetermined length and then by bending it around an angle of approximately 90° by means of a suitable bending tool to produce an arc-shaped section at a predetermined location to serve as the connecting segment of the track. In the case of the guide rail arrangement described in this document, various radii of curvature can be used for the part of the connecting section which merges with the horizontal guide rail section at one end and for the part of the connecting section which merges with the more-or-less vertical guide rail section at the other end.

The assembly of these known guide rail arrangements and their transport to the installation site have turned out to be problematic, because, when the guide rails are produced as single units as described above, they are 5 m or more long when transported to the installation site, where they are then bent to shape. In cases where the rails are bent at the factory, they measure more than 2.5 m in each of two more-or-less perpendicular directions.

In view of this problem, U.S. Pat. No. 6,047,761 proposes a modular guide rail arrangement of the type described above, in which the straight segments of the track which guides the movement of the door leaf are formed by separate rail elements. This facilitates the transport of the guide rail arrangement and also simplifies the installation of the guide rail arrangement by eliminating the bulkiness of the guide rails.

In the case of the modular guide rail arrangement described in the document cited above, the connecting segment can be produced as a single unit with one of the straight guide rail sections.

In an advantageous embodiment of the . . . in U.S. Pat. No. 6,047,761, the connecting segment is realized as an additional rail element with the approximate shape of an arc of a circle. Each of the two ends of this rail element is connected to one of the straight guide rail elements. As a result, the straight rail elements can be adapted to different installation geometries simply by replacing the rail element which forms the connecting segment.

In an elaboration of this modular guide rail arrangement described in DE 198 57 670 A, installation with different geometries is made possible by the use of only a single rail element, which forms the connecting segment. This single element has a more-or-less circular arc-shaped section, one end of which merges with a more-or-less straight section of the rail element.

It has been found, however, that the installation of the guide rail arrangements described in the last document cited above is associated with a comparatively large amount of time and money. In view of these problems of the state of the art, the invention is based on the task of producing a guide rail arrangement of the type described above which, first, can be transported without undue effort and which, second, can also be installed easily.

This task is accomplished according to the invention by an elaboration of the known guide rail arrangements, characterized essentially in that each of the rail elements has an essentially straight section and a circular arc-shaped section, which is connected to the end of the straight section. The arc-shaped section is produced as an integral part of the straight section and helps to form the connecting segment.

As a result, the guide rail arrangement can be installed more easily than the guide rail arrangement described in DE 198 57 670 A, because, to form the track which guides the door leaf, only two rail elements must be installed at each lateral edge of the door leaf, each of these rail elements having a straight section and an arc-shaped section, which forms part of the connecting segment between the straight sections of the guide rail made up of the two rail elements.

At the same time, this design of the rail elements also makes it possible to transport the entire guide rail arrangement more easily, because the individual rail elements are relatively short in the direction perpendicular to the straight sections. This is made possible by the fact that the connecting segment is composed of two arc-shaped sections, one of which is located at one end of each straight section. This guarantees that the dimensions of the rail elements in the direction perpendicular to the straight sections is less than the radius of curvature of the arc-shaped sections, because the overall bending angle, which is usually about 90°, is split between the two arc-shaped sections.

In the guide rail arrangements according to the invention, it can be guaranteed that the door leaf will move smoothly between the straight and the arc-shaped sections of the rail elements by merging the straight sections tangentially with the ends of the arc-shaped sections facing them.

The transport of the inventive guide rail arrangements can be facilitated even more when, for at least one of the rail elements, a tangent to the end of the arc-shaped section facing away from the straight section encloses an acute angle of less than 45° with a line parallel to the straight section, because in this way the dimensions of the rail elements in the direction perpendicular to the straight section can be reduced even further. It has also been found that, with rail elements of this type, it is possible for the movement of the door leaf to be guided smoothly even when the facing ends of the arc-shaped sections of the two rail elements merge into each other not tangentially but rather in such a way that tangents to the ends of the arc-shaped sections facing away from the straight sections form an acute angle, this acute angle being less than 15°, and preferably less than 10°. In this way, the overall construction height of the inventive guide rail arrangement can be reduced without changing the length of the straight sections of the rail elements, because, for given radii of curvature of the arc-shaped segments, a change of direction of approximately 90° is possible even when the horizontal guide rail section is located at a distance above the upper end of the vertical guide rail section which corresponds to less than the radius of curvature of the arc-shaped sections.

As a result, it is possible to install the inventive guide rail arrangements for a predetermined drive-through height even in spaces with low ceilings.

When the conventional guide rail arrangements for overhead sectional doors are installed, the straight guide rail sections extending essentially in the horizontal direction overhead are usually fastened by means of appropriate fastening elements to the ceiling of the room to be sealed off by the door, whereas the straight guide sections extending essentially in the vertical direction are usually attached to the lateral uprights of the door frame. Therefore, for rooms of different heights, the heights which must be bridged between the straight horizontal overhead guide rail sections and the floor of the room to be closed by the door will vary correspondingly. For visual reasons and to avoid damage, it is usually also necessary to pay attention to the fact that, when in the open position, the door leaf is completely covered by an apron, which merges with the ceiling and which forms the boundary of the top of the drive-through height of the garage entrance, which is closed by the door leaf when the door is closed. For a given drive-through height in the open position of the door leaf, therefore, a separate guide rail arrangement is usually required for each installation situation, that is, for each ceiling height and for each apron height. This problem can be solved with the help of an inventive guide rail arrangement by providing the rail elements with straight sections of different lengths. With a guide rail arrangement of this type, an especially large gap between the floor of the room to be closed by the door and the guide rail sections extending horizontally overhead—a situation which can occur in cases where the ceiling is especially high—can be bridged by the use of a rail element with a longer straight section to form the essentially vertical segment of the guide track, whereas the rail element with a shorter straight section will be used to form the essentially horizontal overhead segment of the guide track. In this case, when the longer, more-or-less straight section of one of the rail elements is used to form the vertical segment of the guide track, a specified drive-through height can be guaranteed even when the edge of the door leaf which is at the bottom when the door is closed is, when the door is open, located below the overhead horizontal guide rail section in the area of the connecting segments formed by the arc-shaped sections of the rail elements, where it is at least partially covered by an apron of appropriate height. Therefore, for the installation situation described above in a room with a high ceiling, it is possible to use a straight, overhead horizontal section which is actually shorter than the drive-through height of the entry opening to be closed by the door.

When an inventive guide rail system is installed in a room with a comparatively low ceiling, the rail element with the shorter straight section can be used to form the approximately vertical segment of the guide track. As a result, the overall guide rail arrangement will not be as high. On the other hand, through the use of the longer straight section to form the overhead horizontal segment of the guide track, sufficient space is provided, when the door is open, for the acceptance, between the horizontal guide rail section, of the edge of the door leaf which is at the bottom when the door is closed, where a guide element, fastened to the edge of the door leaf which is at the bottom when the door is closed, will be located at approximately on the same level as the other guide elements, which are accommodated in the horizontal straight guide rail section when the door is open. With the most recently described installation arrangement of an inventive guide rail arrangement, it is therefore possible to ensure a specified drive-through height even when the ceiling is low, where the edge of the door leaf which is at the bottom when the door is closed is at least partially covered by a comparatively low apron when the door is open.

As already explained above, it has been found to be especially favorable as a way of ensuring the smooth and quiet movement of the door leaf if the guide rail is designed to accept a guide rail element in the form of a guide roller fastened to a leaf of the door, the roller being attached to the leaf so that it can rotate around an axis of rotation which is more-or-less perpendicular to the path of the door leaf defined by the guide rail arrangement. The guide rail elements of a guide rail of the inventive guide rail arrangement can in this case be used in both of the installation geometries explained above, that is, for installation in a room with a high ceiling and for installation in a room with a comparatively low ceiling, provided that, after proper installation, they are approximately mirror-symmetric to a plane passing through the straight sections parallel to the . . . .

As in the case of the known guide rail arrangements, it has been found to be especially advisable as a way of ensuring the smooth guidance of the movement of the door leaf between the closed position and the open position for the inventive guide rail arrangements to have two guide rails, which can be fixed in place at opposite edges of a door leaf of the door, each of these rails consisting of at least two straight sections and one connecting segment, formed by the arc-shaped sections integral to the straight sections. If these types of guide rails have been designed to accept guide rollers, which are attached to the door leaf so that they rotate around an axis perpendicular to the path defined by the guide rail arrangement, it has been found to be especially advantageous for safety reasons for the rail elements to enclose the guide rollers on three sides and to have a slot which extends along the defined track and which is open only in the direction toward the door leaf. In this case, the rail element which was installed on one side during installation of the guide rail arrangement in a room with a high (low) ceiling can be located in the area of the other edge of the door leaf to produce a guide rail arrangement suitable for installation in a room with a low (high) ceiling, if it can be converted into the other rail element by reflection in a plane parallel to the straight sections.

As previously explained, the inventive guide rail arrangement can be used to particular advantage in conjunction with a sectional door with a door leaf which can move along a track defined by the guide rail arrangement between a closed position and an open position, where the door leaf has a plurality of hinges, which connect panels pivotably to each other and which are arranged sequentially in the direction of the defined track, the axes of the hinges being perpendicular to the defined track. If the main surface of the door leaf is approximately in a vertical plane when the door is closed and approximately in a horizontal plane when the door is open, i.e., in the overhead position, each guide rail of the guide rail arrangement advisably has a straight section which, when the door is closed, is more-or-less parallel to the down-hanging door leaf, and a straight section which is connected to the first section by the arc-shaped sections formed as integral parts of the straight sections, this second section being, when the door is open, more-or-less parallel to the horizontally extending door leaf.

As can be derived from the preceding description of the inventive guide rail arrangement, a rail element which can be used to produce the guide rail arrangement is characterized essentially in that it has a straight section and an arc-shaped section, which is produced as an integral part of the straight section and which forms the connecting segment, where a tangent to the end of the arc-shaped section facing away from the straight section encloses an acute angle of less than 90°, and preferably of less than 45°, with a straight line extending parallel to the straight section.

The invention is explained by reference to the drawing, to which explicit reference is made with respect to all of the details which are essential to the invention but not discussed in detail in the description:

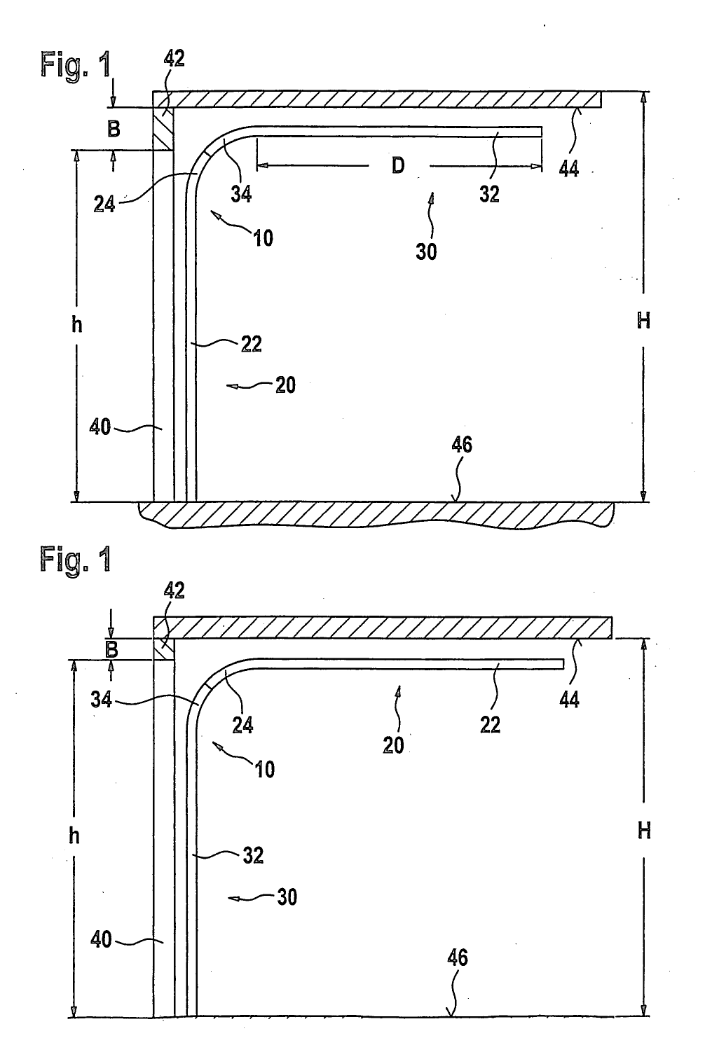

FIG. 1 shows a schematic side view of an inventive guide rail arrangement installed in a room with a high ceiling;

FIG. 2 shows a schematic side view of the guide rail arrangement according to FIG. 1 installed in a room with a comparatively low ceiling; and

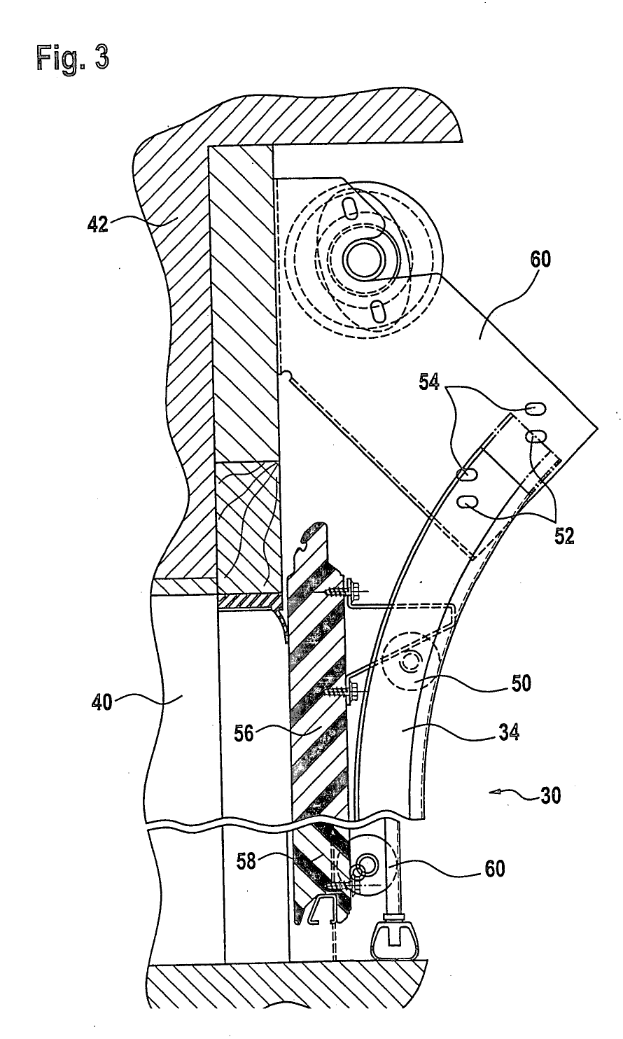

FIG. 3 shows a side view of an inventive rail element.

The guide rail arrangement shown in FIG. 1 comprises a guide rail, designated overall by the reference number 10. This guide rail 10 is formed out of two rail elements 20 and 30, each of which has a straight section 22, 32, and an arc-shaped section 24, 34, which is an integral part of the straight section. The straight sections 22, 32 are more-or-less tangential to the ends of the arc-shaped sections 24, 34 which face them.

The straight section 22 of the rail element 20 proceeds approximately in the vertical direction from the bottom 46 of a garage toward the garage ceiling 44. The straight section 32 of the rail element 30 extends more-or-less horizontally underneath the garage ceiling 44. The straight section 22 of the rail element 20 is longer than the straight section 32 of the rail element 30. As a result, the guide rail 10 shown in FIG. 1 can be installed in a garage with a comparatively high ceiling of height H between the floor 46 and the ceiling 44 of the garage.

The garage has an entry 40 with a drive-through height h, which is limited at its top edge by an apron 42 with a height B. The straight horizontal section 32 of the rail element 30 is attached by suitable fastening elements (not shown) to the ceiling 44 of the garage overhead, whereas the straight vertical section 22 of the rail element 20 is attached to a vertical upright of the door frame (not shown), which is attached in turn to a wall facing the entry 40. The straight sections 32 and 22 are connected to each other by the arc-shaped sections 34, 24, which are integral parts of the straight sections. The guide rail 10 serves to guide the movement of a door leaf (not shown) between a closed position, in which it is more-or-less parallel to the vertical guide rail section 22, and an open position, in which it is more-or-less parallel to the horizontal guide rail section 32. The length D of the horizontal guide rail section 32 is slightly shorter that the drive-through height h of the garage entry 40. Therefore, a guide roller, which is located at the edge of the door leaf which rests on the floor 46 when the door is closed, is, when the door is open, located in the area of the arc-shaped section 34 of the rail element 30, slightly below the other guide rollers, which are accommodated in the straight section 32 of the rail element 30 when the door is open. Because the straight section 22 of the rail element 20 is longer than the straight section 32 of the rail element 30, however, it is ensured that the edge of the door leaf which is at the bottom when the door is closed will, when the door is open, leave a sufficient amount of drive-through space free, where the apron 42, when the door is open, forms an advantageous cover for the edge of the door leaf which is at the bottom when the door is closed, this being done for the sake of visual appearance and also to increase the operational reliability.

FIG. 2 shows the installation of the guide rail 10 explained on the basis of FIG. 1 in a garage with a ceiling of lower height H between the floor 46 and the ceiling 44. The rail element 30 is attached to an upright frame piece, not shown in the drawing, so that the straight section 32 is more-or-less vertical, whereas the rail element 20 is attached to the ceiling 44 of the garage, so that the straight section 22 is more-or-less horizontal. This installation is made possible by the fact that the straight section 32 of the rail element 30 is shorter than the straight section 22 of the rail element 20. At the same time, the fact that the straight section 22 is longer than the straight section 32 also guarantees that the edge of the door leaf which rests on the floor when the door is closed will, when the door is open, be located in the area of the straight section 22 at approximately the same level as the rest of the door leaf. As a result, by the use of the guide rail 10, it is possible, by exchanging the rail elements, to obtain the same drive-through height on installation in a garage with a comparatively low ceiling as that which is obtained when this same guide rail 10 is installed in a garage with a comparatively high ceiling, where the edge of the door leaf which rests on the floor 46 in the closed position will, when the door is open, be at least partially covered by the apron 42′.

The door shown in FIG. 3 consists essentially of a door leaf 40 and a guide rail arrangement, of which only one rail element 30 is shown in FIG. 3 in the installation position explained on the basis of FIG. 2. The door leaf 40 comprises a total of 4 panels, arranged next to each other in the direction of the guide rail arrangement. Only the uppermost panel 42 and the lowermost panel 44, which rests on the floor 46 when the door is closed, are shown in the drawing. The panels of the door leaf 40 are connected to each other by hinges with axes which are perpendicular to the rail element 30. At the upper edge of the panel 42 and also at the upper edge of the panel 44 there is a guide roller 50, mounted rotatably on an axis of rotation which is perpendicular to the rail element 30. Another guide roller 60 is attached to the lower edge of the lower panel 44, shown in the closed position in FIG. 3. The guide rollers 50 and 60 are held in the rail element 30. The rail element 30 shown in the drawing comprises a straight section (not shown) and the arc-shaped section 34 (shown), which forms an integral part of the straight section. A tangent laid to the end of the arc-shaped section 34 facing away from the straight section encloses an angle of less than 45° with a straight line parallel to the straight section. As a result, the overall height of the guide rail arrangement is reduced, as can be seen from a comparison between the guide rails 30 shown in solid line and a guide rail, shown in dash-dot line, with an arc-shaped section covering an angle of 45°. The rail element 30 in the embodiment of the invention shown in FIG. 3 is attached by a bracket 60 to an apron 42. At the edge facing the rail element 30, the bracket has a total of four mounting holes 52, 54. The mounting holes 52 are provided so that the rail elements can be mounted in the position explained on the basis of FIG. 2, whereas the mounting holes 54 are used to install the rail elements in the position explained on the basis of FIG. 1.

The invention is not limited to the exemplary embodiments explained on the basis of the drawing. On the contrary, it is also intended that the inventive guide rail arrangements could also be used with an additional rail element serving to guide the roller attached to the upper edge of the uppermost panel of a door leaf. The arrangement of this type of additional rail element is explained in DE 198 57 670 A on the basis of FIGS. 3 and 4. The disclosure content of this document is herewith included in the present specification with respect to the arrangement of this additional rail element. The inventive guide rail arrangement can also have rail elements with straight sections of equal length to simplify installation for specified installation geometries. Although, in a preferred embodiment of the invention, the arc-shaped sections extend over the same angles, it is also intended that rail elements with arc-shaped sections extending over different angles can be used.

1. Door, especially a sectional door, with a door leaf and a guide rail arrangement to form a track for guiding the movement of the door leaf between an open position and a closed position, the track comprising two more-or-less straight segments and a connecting segment joining the two straight segments, with two rail elements (20, 30), each of which serves to form a straight segment, which rail elements can be assembled to form a guide rail in such a way that the straight segments of the track enclose an angle of less than 180°, and preferably of approximately 90°, with each other, each of the rail elements (20, 30) consisting of an essentially straight section (22, 32) and a circular arc-shaped section (24, 34), which is located at the end of the straight section (22, 32) and which is produced as an integral part thereof to form the connecting segment, wherein, after the rail elements (20, 30) have been assembled so that the straight sections (22, 32) are at an angle of 90′ to each other, the tangents to the ends of the arc-shaped sections (24, 34) facing away from the straight sections (22, 32) enclose with each other an acute angle of more than 3′, preferably of more than 5°, and less than 15°, preferably of less than 10°.

2. Door according to claim 1, wherein the straight section (22, 32) is tangential to the end of the arc-shaped section (24, 34) which faces it.

3. Door according to claim 1, wherein, for at least one rail element (10, 20), a tangent to the end of the arc-shaped section facing away from the straight section encloses an acute angle of 45° or less with a straight line parallel to the straight section (22, 32).

4. Door according to claim 1, wherein the straight sections (22, 32) of the rail elements are of different lengths.

5. Door according to claim 1, wherein the rail elements (20, 30) are designed to receive a guide element (50, 60) such as a guide roller attached to the door leaf.

6. Door according to claim 1, comprising two guide rails (10), which can be fixed in place in the area of the opposite edges of the door leaf (40), each rail having two rail elements with a straight section and an arc-shaped section formed as an integral part of the straight section, where at least one of the rail elements can be converted into a different rail element by reflection in a plane.
